(19) United States
(12) Patent Application Publication
(10) Pub. No.: US 2018/0015854 A1
(43) Pub. Date: Jan. 18, 2018

(54) SEAT STRUCTURE FOR VEHICLE

(71) Applicant: HYUNDAI DYMOS INCORPORATED, Seosan-si (KR)

(72) Inventors: Hyeok SONG, Suwon-si (KR); Yeong Jin KIM, Hwaseong-si (KR); Man Seock KIM, Hwaseong-si (KR)

(73) Assignee: HYUNDAI DYMOS INCORPORATED, Seosan-si (KR)

(21) Appl. No.: 15/652,435

(22) Filed: Jul. 18, 2017

(30) Foreign Application Priority Data
Jul. 18, 2016 (KR) 10-2016-0090634

(51) Int. Cl. B60N 2/46; B60N 2/22

(52) U.S. Cl. CPC B60N 2/4633; B60N 2/22

(57) ABSTRACT

Disclosed is a vehicle seat structure. The seat structure includes a seatback rotatably provided, an armrest bracket rotatably provided to the seatback, and a link member having an upper end and a lower end, wherein the upper end is hinge-coupled to the armrest bracket such that the upper end is spaced apart a distance from a rotary axis of the armrest bracket, and the lower end is hinge-coupled to a mounting member such that the lower end is spaced apart a distance from a rotary axis of the seatback, so as to allow the armrest bracket to be rotated to restrict a longitudinal direction of the armrest relative to a horizontal direction from being varied during the rotation of the seatback.

### CROSS-REFERENCE TO RELATED APPLICATIONS

This application claims priority to and the benefit of Korean Patent Application No. 10-2016-0090634, filed Jul. 18, 2016. The disclosure of the above application is incorporated herein by reference.

### FIELD

The present disclosure relates to a seat structure for a vehicle, wherein the seat structure allows an occupant to be seated comfortably on a seat in a vehicle.

### BACKGROUND

The statements in this section merely provide background information related to the present disclosure and may not constitute prior art.

Generally, vehicles have seats on which an occupant such as a driver or a passenger can be seated comfortably and stably. In the case of car, a front seat including a driver seat and a rear seat may be provided in an interior space.

In the meantime, vehicle seats may adopt a variety of technologies for comfort of occupants, particularly armrests that support an occupant's arm with ease.

The armrest is an elongated member that is provided on either side of a seatback in a longitudinal direction of a vehicle. Particularly, in a rear seat section, the armrest may be provided between a left seat and a right seat.

However, in the structure that the armrest is coupled to the seatback, when an occupant tilts his/her seat back for his/her comfortable seating, the armrest also tilts back along with the seatback so that a front end side thereof tilts upwards.

In this case, despite the intention of the occupant to tilt the seatback only, the armrest tilts together to cause inconvenience of use.

### SUMMARY

The present disclosure provides a vehicle seat structure having an armrest, whereby the seat structure is able to maintain or separately regulate a tilted angle of the armrest even during tilting of a seatback for the occupant's comfort.

According to one form, the present disclosure provides a vehicle seat structure including: a seatback that is provided in a manner of being rotatable about a lower end thereof; an armrest bracket that is rotatably provided on either side of the seatback and to which an armrest is coupled; and a link member having an upper end and a lower end, wherein the upper end is hinge-coupled to the armrest bracket such that the upper end is spaced apart a distance from a rotary axis of the armrest bracket, and the lower end is hinge-coupled to a mounting member such that the lower end is spaced apart a distance from a rotary axis of the seatback, so as to allow the armrest bracket to be rotated to restrict a longitudinal direction of the armrest relative to a horizontal direction from being varied during the rotation of the seatback.

The mounting member to which the lower end of the link member is hinge-coupled may be a seatback bracket to which a lower end of the seatback is hinge-coupled.

The link member may not intersect with an imaginary reference line connecting the rotary axis of the seatback and the rotary axis of the armrest bracket.

The upper end of the link member may be spaced backwards from the rotary axis of the armrest bracket.

The armrest bracket, to which the armrest having a protrusion is hinge-coupled, may be provided with a guide groove along which the protrusion is moved and guided within a limited rotation range, thereby allowing the armrest to be rotated within the limited rotation range defined by the guide groove.

According to the present disclosure, the seat structure is able to maintain or separately regulate a rotation angle of the armrest even during rotation of the seatback for the occupant's comfort.

Further, the armrest bracket to which the armrest is coupled is provided so as to be rotatable, and the link member is provided so as to be hinge-coupled to a location spaced apart from the rotary axis of the armrest bracket, thereby forming a different rotation angle of the armrest from a rotation angle of the seatback even during rotation of the seatback.

Further, the lower end of the link member is hinge-coupled to the seatback bracket to which the seatback is hinge-coupled, which is advantageous in design because there may not be a need to provide a separate mounting structure for the link member, and is capable of providing relative rotation of the armrest bracket.

Further, the link member does not intersect with the imaginary reference line connecting the rotary axis of the seatback and the rotary axis of the armrest bracket such that the link member is spaced backwards from the reference line, thereby maintaining an angle of the longitudinal direction of the armrest relative to the horizontal direction to be constant even during rotation of the seatback.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view illustrating a vehicle seat structure according to one form of the present disclosure;

FIG. 2 is a schematic view illustrating a state in which a seatback is tilted back in a seat structure according to the present disclosure; and

FIG. 3 is a side view illustrating a state in which a seatback is folded in a seat structure according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinbelow, exemplary forms of the present disclosure will be described with reference to the accompanying drawings.

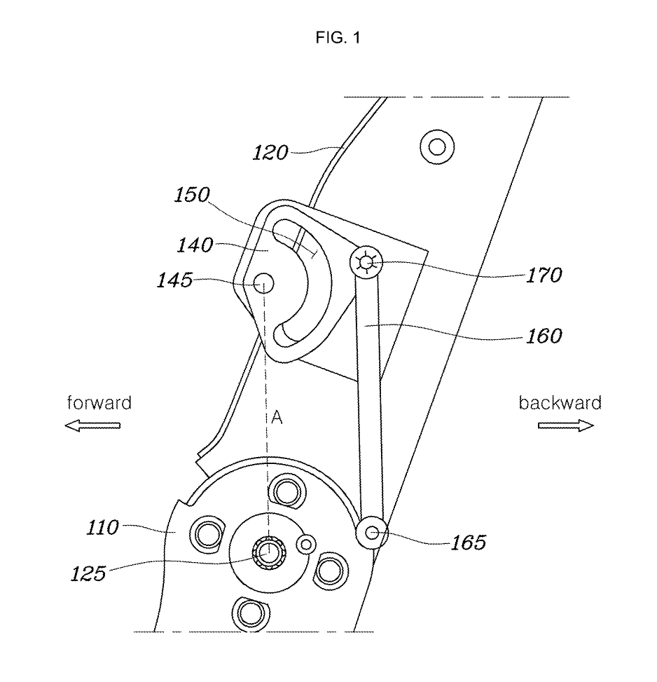

As illustrated in FIGS. 1 to 3, a vehicle seat structure according to one form of the present disclosure includes: a seatback 120 that is provided in a manner of being rotatable about a lower end thereof; an armrest bracket 140 that is rotatably provided on either side of the seatback 120 and to which an armrest 180 is coupled; and a link member 160 having an upper end 170 and a lower end 165, wherein the upper end 170 is hinge-coupled to the armrest bracket 140 such that the upper end is spaced apart a distance from a rotary axis 145 of the armrest bracket 140, and the lower end 165 is hinge-coupled to a mounting member 110 such that the lower end is spaced apart a distance from a rotary axis 125 of the seatback 120, so as to cause the armrest bracket 140 to be rotated to restrict a longitudinal direction (B) of the armrest 180 relative to the horizontal direction from being varied during the rotation of the seatback 120.

In one form, the seatback 120 is provided so as to be rotatable about the lower end thereof. The lower end of the seatback 120 is hinge-coupled to a member secured to a vehicle body, and in one form, in a rotatable manner. A lock device such as a recliner or the like may be provided on the lower end side of the seatback 120 in order to lock or unlock a current rotary angle of the seatback 120.

The seatback 120 may be provided to each of left and right seats, or otherwise may be integrally provided to the left and right seats as an integral framework over the left and right seats. As described below, the armrest 180 may be provided between the left seat and the right seat.

Further, the seatback 120 may be provided in “a folded state” that means herein a state that the seatback is rotated forward to and comes into close contact with a seat cushion as the bottom of a seat in order to increase spatial utility.

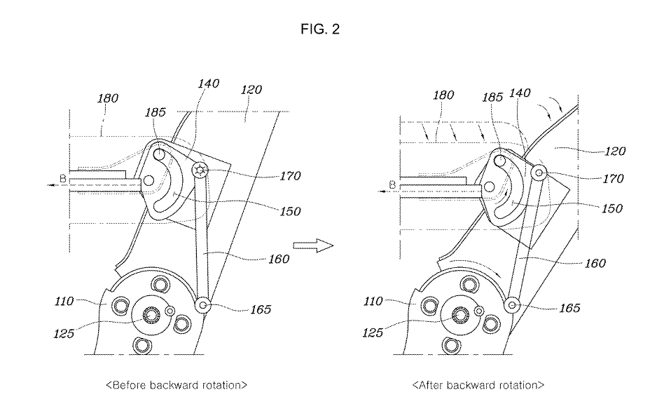

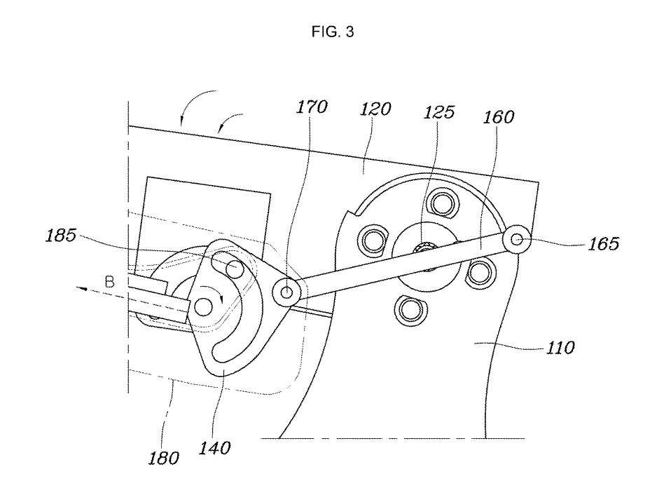

FIGS. 1 to 3 illustrate the seat structure showing the profile of the seatback 120. FIG. 2 shows the seatback 120 rotated backwards, and FIG. 3 shows the seatback 120 maximally rotated forwards into a folded state.

The armrest bracket 140 is rotatably provided on either side of the seatback 120 such that the armrest 180 can be coupled thereto. The armrest bracket 140 is a member to which the armrest 180 is to be coupled, and is disposed on either side of the seatback 120. Thus, the armrest 180 is located at the side of the seatback 120 and is coupled to the armrest bracket 140 that is provided so as to be rotatable relative to the seatback 120, thereby providing the structure in which the armrest 180 is rotatable relative to the seatback 120.

The armrest bracket 140 may have a variety of shapes so that the armrest bracket may be rotatably hinge-coupled directly to the side of the seatback 120, or otherwise may be rotatably mounted to a separate member that is provided on the seatback 120.

The armrest 180 may be provided to have a longitudinal direction (B) parallel with the horizontal direction when the seatback 120 is positioned substantially perpendicular to the horizontal direction. The armrest 180 and the armrest bracket 140 may be coupled together by inserting the armrest bracket 140 into an outer cover of the armrest, or otherwise directly coupling the armrest bracket 140 and the outer cover.

The armrest bracket 140 is shown in FIGS. 1 to 3. Particularly in FIGS. 2 and 3, the armrest bracket 140 that is being rotated relative to the seatback 120 during rotation of the seatback 120 is shown.

The link member 160 is configured such that the upper end 170 is hinge-coupled to the armrest bracket 140 such that the upper end is spaced apart a distance from the rotary axis 145 of the armrest bracket 140, and the lower end 165 is hinge-coupled to the mounting member 110 such that the lower end is spaced apart a distance from the rotary axis 125 of the seatback 120, so as to cause the armrest bracket 140 to be rotated to restrict the longitudinal direction (B) of the armrest 180 relative to the horizontal direction from being varied during the rotation of the seatback 120.

In the structure in which the link member 160 is not provided, the armrest bracket 140 is freely rotatable from the side of the seatback 120. However, when the link member is provided such that the upper end 170 thereof is hinge-coupled to the armrest bracket 140 and the lower end 165 is hinge-coupled to the mounting member 110, the armrest bracket 140 is restricted from being freely rotated. That is, the armrest bracket 140 changes in the rotation angle according to rotation states of the seatback 120 and the link member 160.

The link member 160 may be provided to substantially extend from the seat cushion towards the ceiling of a vehicle when the seatback 120 is positioned perpendicular to the horizontal direction. The link member may be composed of metal, rubber, or a plastic material, and may be inextensible.

The upper end 170 of the link member 160 is hinge-coupled to the armrest bracket 140 at a position spaced apart a distanced from the rotary axis 145 of the armrest bracket 140. If the upper end 170 of the link member 160 is hinge-coupled to the rotary axis 145 of the armrest bracket 140, the armrest 180 and the armrest bracket 140 become freely rotatable so that the armrest may not support the occupant's arm properly.

Since the rotary axis 125 of the seatback 120 and the lower end 165 of the link member 160 are in a fixed state, if the rotary axis 145 of the armrest bracket 140 and the upper end 170 of the link member 160, which are fixed relative to the side of the seatback 120, are set to the same position, rotation of the seatback 120 is restricted so that it is not possible to regulate the rotation angle of the seatback 120.

That is, according to the present disclosure, the upper end 170 of the link member 160 is coupled to the armrest bracket at a position spaced apart a distance from the rotary axis 145 of the armrest bracket 140, thus enabling support of the occupant's arm and regulation of the rotation angle of the seatback 120 through restricted rotation of the armrest 180.

Here, the upper end 170 of the link member 160 may be tilted in many directions from the rotary axis 145 of the armrest bracket 140. In one form, the upper end may be tilted backwards from the rotary axis 145 of the armrest bracket 140. FIGS. 1 to 3 show that the upper end 170 of the link member 160 is hinge-coupled to the armrest bracket at a position spaced backwards from the rotary axis 145 of the armrest bracket 140 when considering the case where the seatback 120 is fixed perpendicular to the horizontal direction.

In the meantime, the lower end 165 of the link member 160 is hinge-coupled to the mounting member 110 that is fixedly positioned irrespective of the rotation of the seatback 120. Here, the lower end 165 of the link member 160 is hinge-coupled at a position spaced apart a distance from the rotary axis 125 of the seatback 120.

Thus, the armrest bracket 140, to which the upper end 170 of the link member 160 is hinge-coupled, is able to be rotated differently from the rotation of the seatback 120. That is, the armrest bracket 140 is rotated relative to the seatback 120 being rotated by the rotation about a portion, to which the upper end 170 of the link member 160 is coupled, together with the rotation about the rotary axis 145 fixed to the seatback 120.

As a result, the armrest 180 coupled to the armrest bracket 140 is rotation-supported by the rotary axis 145 of the armrest bracket 140 and the upper end 170 of the link member 160, so that the armrest can stably support the occupant's arm within a restricted rotation range despite the load applied by the arm. At the same time, during the rotation of the seatback 120, the armrest can rotate in a different range from the rotation of the seatback 120, because a portion of the armrest bracket, to which the upper end 170 of the link member 160, which is not fixed to the seatback 120, is coupled, is rotated relative to the seatback 120.

An operational feature of the above-mentioned structure will be described in detail, compared to that of a conventional structure in which the armrest bracket 140 is coupled to the side of the seatback 120 in a fixed-rotation state.

First, in the case of the fixed-rotation state armrest 180, when the seatback 120 rotates about the rotary axis 125, the armrest bracket 140 and the armrest 180, which are restricted from being rotated, rotate along with the seatback 120.

Particularly, when the seatback 120 is rotated backwards (in a vehicle), the armrest 180 rotates along with the seatback 120 so that a front end thereof, particularly, tilts upwards. That is, the longitudinal direction (B) of the armrest 180 also tilts upwards.

In this case, if the armrest 180 rotates along with the seatback 120, an occupant who intends to rotate only the seatback 120 backwards will suffer from inconvenience with use of the armrest 180.

On the contrary, in the case of the present structure in which relative rotation of the armrest 180 and the armrest bracket 140 to the seatback 120 is allowable by the provision of the link member 160, when the seatback 120 rotates about the rotary axis 125, the armrest 180 and the armrest bracket 140, which are rotatably fixed to the seatback 120, rotate relative to the seatback 120 during the rotation of the seatback 120 such that the longitudinal direction (B) of the armrest 180 changes in a different rotation range from that of the seatback 120.

Particularly, when the seatback 120 rotates backwards, the front part of the armrest 180 is inhibited or restricted from being tilted upwards by relative rotation to the seatback 120.

In one form of the present disclosure, the link member 160 is configured to allow the length and the longitudinal direction (B) of the armrest 180 to be kept constant even when the seatback 120 rotates.

In other words, when the seatback 120 fixed perpendicular to the horizontal direction is rotated forwards or backwards, a portion of the armrest bracket 140 around the rotary axis 145 rotates about the rotary axis 125 of the seatback 120, whereas a portion of the armrest bracket 140, to which the upper end 170 of the link member 160 is coupled, rotates about the lower end 165 of the link member 160, so that the two portions rotate in a different rotation path. Particularly, it is configured such that even during the rotation of the two portions, the rotary axis 145 of the armrest bracket 140 and the portion of the armrest bracket 140, to which the upper end 170 of the link member 160 is coupled, have substantially the same height from the bottom, thereby maintaining the longitudinal direction (B) to be constant even when the seatback 120 rotates.

FIG. 1 shows the link member 160, in which the upper end 170 is hinge-coupled to the armrest bracket 140 and the lower end 165 is hinge-coupled to the mounting member 110, and the armrest bracket 140 of which rotation range is defined by the link member 160.

FIG. 2 shows the armrest bracket 140 that rotates relative to the seatback 120 by the operation of the link member 160 when the seatback 120 rotates backwards. Particularly in FIG. 2, during backward rotation of the seatback 120, the armrest bracket 140 rotates about the rotary axis 145 in opposite direction to the rotation of the seatback 120 in response to the operation of the link member 160, thereby maintaining the longitudinal direction (B) of the armrest bracket 120 to be constant.

FIG. 3 shows that when the seatback 120 is being rotated forwards and folded, the armrest bracket 120 rotates about the rotary axis 145 relative to the seatback 120 in opposite direction to the rotation of the seatback 120 in response to the operation of the link member 160, thereby maintaining the longitudinal direction (B) of the armrest bracket 180 parallel with the horizontal direction.

As a result, according to the present structure in which the armrest 180 is coupled to the side of the seatback 120, the armrest bracket 140 to which the armrest 180 is coupled is rotatably coupled to the seatback 120, and the link member 160 is provided so as to allow the armrest bracket 140 to be rotated relative to the seatback 120, so that the armrest 180 and the armrest bracket 180 rotate in a different rotation range from that of the seatback 120, thereby maintaining the longitudinal direction (B) of the armrest 180 to be constant and thus improving convenience of use of the seat structure.

In the meantime, as illustrated in FIGS. 1 to 3, in the seat structure according to the present disclosure, the mounting member 110 to which the lower end 165 of the link member 160 is hinge-coupled corresponds to a seatback bracket 110 to which a lower end of the seatback 120 is hinge-coupled.

Specifically, the seatback 120 is provided so that the lower end thereof is rotatably hinge-coupled to the seatback bracket 110. The seatback bracket 110 corresponds to a mounting member that is fixedly provided to a vehicle body, so that the lower end 165 of the link member 160 is hinge-coupled to the seatback bracket 110.

Such a structure is shown in FIGS. 1 to 3. Thus, this form of the present disclosure is advantageous in design in rotatably fixing the lower end 165 of the link member 160 without a separate mounting member.

In the meantime, as illustrated in FIGS. 1 to 3, in the seat structure according to the present disclosure, the link member 160 is provided such that the link member does not intersect with an imaginary reference line (A) connecting the rotary axis 125 of the seatback 120 and the rotary axis 145 of the armrest bracket 140.

That is, the reference line (A) and the link member 160 are provided substantially parallel with each other so that they do not intersect with each other. If the link member 160 is provided, intersecting with the reference line (A), during rotation of the seatback 120, the relative rotation of the armrest bracket 140 is excessively performed, so that the longitudinal direction (B) of the armrest 180 excessively tilts, which is disadvantageous.

For example, in the case where the lower end 165 of the link member 160 is positioned backwards from the reference line (A) and the upper end 170 of the link member 160 is positioned forwards from the reference line (A), when the seatback 120 rotates backwards, although the degree of rotation may be different depending on an angle of the longitudinal direction of the link member 160 relative to the horizontal direction and the length of the reference line (A), the link member 160 allows the front side of the armrest bracket 140 to be excessively rotated downwards. Such excessive downward rotation of the armrest bracket and the armrest during rotation of the seatback 120 causes inconvenience to an occupant.

In the meantime, it is assumed that the lower end 165 of the link member 160 is positioned forwards from the reference line (A). In this case, when the link member 160 intersects with the reference line (A) so that the upper end 170 is positioned backwards from the reference line (A), a rotation angle of the armrest 180 during rotation of the seatback 120 disadvantageously increases.

As a result, this form of the present disclosure allows the armrest bracket 140 to be rotated relative to the seatback 120 being rotated so that the front side of the armrest 180 is rotated upwards, thereby inhibiting the occupant's inconvenience. Furthermore, this form provides the structure in which the link member 160 does not intersect with the reference line (A) so that the longitudinal direction (B) of the armrest 180 can be maintained constantly as far as possible despite the rotation of the seatback 120.

FIGS. 1 to 3 shows the structure designed such that the link member 160 and the reference line (A) are provided parallel with each other so that they do not intersect with each other.

In the meantime, as shown in FIGS. 1 to 3, in the seat structure according to the present disclosure, the upper end 170 of the link member 160 is spaced backwards from the rotary axis 145 of the armrest bracket 140.

Specifically, the link member 160 is configured such that the upper end 170 is spaced backwards from the rotary axis 145 of the armrest bracket 140 without intersecting with the imaginary reference line (A) connecting the rotary axis 125 of the seatback 120 and the rotary axis 145 of the armrest bracket 140.

That is, the link member 160 is mounted so as to be spaced backwards from the reference line (A) when the seatback 120 is fixedly positioned substantially perpendicular to the horizontal direction. Here, the link member 160 and the reference line (A) are provided parallel with each other. In other words, this means that angles of the longitudinal line of the link member 160 and the reference line (A) relative to the horizontal direction are set to the same or similar angle.

When the link member 160 is positioned backwards from the reference line (A), load applied to the link member 160 from the occupant's arm greatly decreases. Specifically, the link member is applied with tensile stress other than compressive stress in the longitudinal direction, whereby the tensile stress has an effect of increasing durability of the link member 160.

When describing this structurally, it can be understood that when the link member 160 is positioned backwards from the reference line (A), the rotary axis 145 of the armrest bracket 140 is positioned between the upper end 170 and the location of the link member 160 to which load from the occupant's arm is applied.

From the viewpoint of armrest 180 or armrest bracket 140, the load from the occupant's arm acts as force that is applied towards the ground. Here, the rotary axis 145 of the armrest bracket 140 corresponds to a fixed point that supports the force.

Further, the load from the occupant's arm generates rotation force to the armrest bracket 140. When transferred to the link member 160, the rotation force acts as tensile force to tension the link member 160.

If the link member 160 is positioned forwards from the reference line, the load from the occupant's arm is applied to the link member 160 as a compressive force, so that in the case of the link member 160 whose both upper and lower ends 170 and 165 are hinge-coupled, the link member has the burden of design to accommodate the load.

As a result, this form of the present disclosure is advantageously configured such that the link member 160 is positioned backwards from the reference line (A) so that load transferred to the armrest 180 from an occupant's arm can be stably supported, which is advantageous in increasing durability of the link member, contributing to inhibiting breakage of the link member, for example.

FIGS. 1 to 3 show the link member 160 that is positioned backwards from the reference line (A) connecting the rotary axis 125 of the seatback 120 and the rotary axis 145 of the armrest bracket 140.

In the meantime, as shown in FIGS. 1 to 3, in the seat structure according to this form of the present disclosure, the armrest bracket 140, to which the armrest 180 having a protrusion 185 is hinge-coupled, is provided with a circular guide groove 150 along which the protrusion 185 is moved and guided within a limited rotation range, thereby allowing the armrest 180 to be rotated within the limited rotation range defined by the circular guide groove 150.

Specifically, in the seat structure causing relative rotation of the armrest bracket 140 to the seatback 120 during rotation of the seatback 120, there may be the situation in which, even when the seatback 120 is not rotated so that the relative rotation of the armrest bracket 140 does not occur, the armrest 180 should be only rotated and accommodated in a storage space around the seatback.

For example, when a user intends to use a sitting area more widely, the armrest that extends forwards from the side of the seatback 120 may interfere with the securing of the wide area. In this case, the user can rotate and put the armrest in a storage space to secure a wide sitting area.

To this end, this form of the present disclosure is configured such that the armrest 180 is hinge-coupled to the armrest bracket 180 in such a manner as to be rotatable relative to the armrest bracket 140. Further, in order to inhibit the armrest 180 from being rotated while supporting the occupant's arm, the armrest 180 and the armrest bracket 140 are respectively provided with the protrusion 185 and the guide groove 150 to limit the rotation range of the armrest 180.

The protrusion 185 is formed on the armrest 180. Specifically, the protrusion 185 protrudes from the armrest 180 at a position facing the armrest bracket 140 so as to pass through the guide groove of the armrest bracket 140.

In the meantime, the armrest bracket 140 is provided with the guide groove 150 through which the protrusion 185 passes and is guided. That is, the guide groove 150 serves as a path along which the protrusion 185 is moved and guided.

Thus, this form of the present disclosure can define a movement path of the protrusion 185 by designing the shape of the guide groove 150, thereby setting or limiting the rotation range of the armrest 180.

In another form, the movement path of the protrusion may be formed to be partially circular in order to allow the armrest 180 to be rotated. That is, the guide groove 150 may be formed in the armrest bracket 140 as a through groove having a partially circular shape.

In addition, the armrest 180 supporting the occupant's arm should be fixedly positioned substantially parallel with the horizontal direction of a vehicle when the seatback 120 is fixedly positioned perpendicular to the horizontal direction. In this case, the protrusion 185 is positioned at one end side of the guide groove 150.

That is, when the armrest 180 is positioned parallel with the horizontal direction of a vehicle when the seatback 120 is fixedly positioned perpendicular to the horizontal direction, the guide groove 150 serves to limit the movement range of the protrusion 185 to inhibit the front side of the armrest from being further rotated downwards.

In addition to limiting the rotation range to inhibit downward rotation of the front side of the armrest, according to the occupant's intention, the armrest 180 should be rotated into the storage space in order to inhibit the armrest 180 from extending forwards from the side of the seatback 120. In this case, the armrest 180 should be rotated upwards.

To this end, the guide groove 150 has a partially circular shape that extends from an upper end thereof to a lower end thereof. Here, when the armrest 180 is positioned parallel with the horizontal direction of a vehicle, the protrusion 185 of the armrest is positioned at the upper end of the circular shape. Such guide groove 150 is shown in FIGS. 1 to 3.

Accordingly, the armrest 180 has a rotation range that allows the front side of the armrest to be rotated not downwards, but upwards. When intended to be accommodated in the storage space at the side of the seatback 120, the armrest 180 is rotated upwards into the storage space so that the longitudinal direction thereof becomes parallel with the longitudinal direction of the seatback 120. Thus, the armrest 180 is rotated upwards into the storage space, so that the armrest does not extend forwards from the seatback 120.

FIG. 2 shows the structure and shape of the guide groove 150 that limit the movement range of the protrusion 185 to inhibit the front side of the armrest 180 from being further rotated backwards when the seatback 120 is fixedly positioned substantially perpendicular to the horizontal direction.

FIG. 3 shows the state in which the seatback 120 is folded and at the same time, the armrest 180 is rotated into the storage space at the side of the seatback 120. Here, as described above, the armrest bracket 140 is not rotated for rotation of the armrest 180, but the protrusion 185 is merely moved from one end to the other end of the guide groove 150.

As set forth before, the various forms of the present disclosure provide, in the seat structure in which the armrest 180 is coupled to the side of the seatback 120, that the front side of the armrest 180 unintentionally rotates upwards during backward rotation of the seatback 120. Further, the various forms of the present disclosure are implemented such that the armrest bracket 140 is provided so as to be rotatable so that the relative rotation of the armrest bracket 140 to the seatback 120 can be regulated by means of the link member 160 to allow the longitudinal direction (B) of the armrest 180 to be maintained to be parallel with the horizontal direction especially even during rotation of the seatback 120.

Although various forms of the present disclosure have been described for illustrative purposes, those skilled in the art will appreciate that various modifications, additions and substitutions are possible, without departing from the scope and spirit of the present disclosure as disclosed in the accompanying claims.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A seat structure for a vehicle, the structure comprising:
a seatback configured to rotate about a lower end thereof;
an armrest bracket configured to rotate on either side of the seatback and coupled to an armrest; and
a link member having an upper end and a lower end,
wherein the upper end is hinge-coupled to the armrest bracket such that the upper end is spaced apart a distance from a rotary axis of the armrest bracket,
and the lower end is hinge-coupled to a mounting member such that the lower end is spaced apart a distance from a rotary axis of the seatback so as to allow the armrest bracket to be rotated to inhibit a longitudinal direction of the armrest relative to a horizontal direction from being varied during the rotation of the seatback.

2. The seat structure according to claim 1, wherein the mounting member to which the lower end of the link member is hinge-coupled is a seatback bracket hinge-coupled to a lower end of the seatback.

3. The seat structure according to claim 1, wherein the link member does not intersect with an imaginary reference line connecting the rotary axis of the seatback and the rotary axis of the armrest bracket.

4. The seat structure according to claim 3, wherein the upper end of the link member is spaced backwards from the rotary axis of the armrest bracket.

5. The seat structure according to claim 1, wherein the armrest hinged to the armrest bracket includes a protrusion that is moved and guided within a limited rotation range along a guide groove of the armrest bracket such that the armrest rotates within a limited rotation range defined by the guide groove.
